(19) United States
(12) Patent Application Publication
(10) Pub. No.: US 2007/0276159 A1
(43) Pub. Date: Nov. 29, 2007

(54) Aminoalkyllithium solutions and processes for making the same

(76) Inventors: Terrence E. Hogan, Akron, OH (US); William L. Hergenrother, Akron, OH (US)

Correspondence Address: Jon D. Wood;Chief I.P. Counsel, Bridgestone Americas Holding, Inc., 1200 Firestone Parkway, Akron, OH, 44317, US

(21) Appl. No.: 11/804,022

(22) Filed: May 16, 2007

Related U.S. Application Data
(60) Provisional application No. 60/800,668, filed on May 16, 2006.

(51) Int. Cl. C07F 1/00

(52) U.S. Cl. 564/1; 260/665 R

(57) ABSTRACT

A process for producing an aminoalkyllithium solution, the process comprising reacting an aminoalkylhalide with lithium in the presence of an electride solvent to form a solution of aminoalkyllithium, adding a non-Zerewitinoff solvent having a solubility parameter of at least 18.0 and less than 22.0 MPa^{1/2}, and removing the electride solvent, where said electride solvent and said non-Zerewitinoff solvent are distinct solvents thereby forming a solution of the aminoalkyllithium in the non-Zerewitinoff solvent.

This application claims the benefit of U.S. Provisional Application No. 60/800,668, filed May 16, 2006, which is incorporated herein by reference.

### FIELD OF THE INVENTION

One or more embodiments of the present invention relates to processes for making solutions of aminoalkyllithium compounds and the resulting high concentration solutions therefrom.

### BACKGROUND OF THE INVENTION

Aminoalkyllithium compounds are known. They can be advantageously employed as anionic polymerization initiators to yield polymers that include an amine group at the head of the polymer (i.e., at the initial location of polymerization).

Synthesis of aminoalkyllithium compounds, however, is not trivial. While the lithiated species can result from the direct reaction of an aminoalkylhalide with a lithium, the selection of a proper solvent is important. To begin with, the solvent must be an electride solvent, which includes a solvent that solubilizes electrons. Known electride solvents include tetrahydrofuran and dimethylether. Where tetrahydrofuran has been employed, low temperatures (e.g., below −20° C.) were required to obtain stable solutions. Further, the use of tetrahydrofuran as a solvent may result in low yields of the aminoalkyllithium compound.

Where non-electride solvents are employed, the solution must be maintained at high temperatures (e.g., at least 80° C.) in order to maintain an adequate solution. These high temperatures, however, can give rise to undesirable Wurtz coupling products.

U.S. Pat. No. 5,852,189 discloses a synthetic procedure for preparing aminoalkyllithium compounds in dimethylether. While the use of dimethylether, which is an electride solvent, is an advantageous solvent for preparing aminoalkyllithium compounds, the low boiling point of dimethylether can be disadvantageous for transport, storage, and use of the aminoalkyllithium solutions. To overcome this disadvantage, the '189 patent teaches a process whereby aliphatic hydrocarbon solvents can be added to the solution and the dimethyl ether removed therefrom. While these aliphatic solutions of aminoalkyllithium compounds were an advancement in the prior art, the ability to form concentrated solutions of aminoalkyllithium compounds was limited. In particular, a stable solution of only about 0.3 molar aminoalkyllithium in non-polar aliphatic solvent (e.g., hexanes) could be achieved at standard conditions.

### SUMMARY OF THE INVENTION

One or more embodiments the present invention provides a process for producing an aminoalkyllithium solution, the process comprising reacting an aminoalkylhalide with lithium in the presence of an electride solvent to form a solution of aminoalkyllithium, adding a non-Zerewitinoff solvent having a solubility parameter of at least 18.0 and less than 22.0 MPa^{1/2}, and removing the electride solvent, where said electride solvent and said non-Zerewitinoff solvent are distinct solvents thereby forming a solution of the aminoalkyllithium in the non-Zerewitinoff solvent.

One or more embodiments of the present invention also includes a composition comprising an aminoalkyllithium or the solution thereof, and a non-Zerewitinoff solvent having a solubility parameter of at least 18.0 and less than 22.0 MPa^{1/2} and boiling point below about 60° C. and above about 80° C.

One or more embodiments of the present invention further includes a process for producing an aminoalkyllithium solution, the process comprising reacting an aminoalkylhalide with lithium in the presence of an electride solvent to form a solution of aminoalkyllithium, adding a non-Zerewitinoff solvent or blend thereof having a solubility parameter of at least 18.0 and less than 22.0 MPa^{1/2}, where said electride solvent and said non-Zerewitinoff solvent are distinct solvents, thereby forming a solution of the aminoalkyllithium in the non-Zerewitinoff solvent, and removing the electride solvent.

### DETAILED DESCRIPTION OF ILLUSTRATIVE EMBODIMENTS

In one or more embodiments of the present invention, aminoalkyllithium compounds are prepared by reacting an aminoalkylhalide with lithium within an electride solvent. A non-Zerewitinoff solvent is added to the solution and the electride solvent is removed. The non-Zerewitinoff solvent has a particular solubility parameter, and is distinct from the electride solvent. The process results in stable solutions of aminoalkyllithium compounds that have an advantageously high concentration of aminoalkyllithium compound in solution.

In one or more embodiments, the reaction between an aminoalkylhalide and lithium metal results in the lithium replacing the halide to form the aminoalkyllithium compound. These reactions are known as disclosed in U.S. Pat. No. 5,852,189, which is incorporated herein by reference.

In one or more embodiments, the solvent in which the aminoalkyllithium compound is prepared includes an electride solvent. In one or more embodiments, the solvent includes at least 50% by volume, in other embodiments at least 75% by volume, in other embodiments at least 90% by volume, and in other embodiments 100% by volume electride solvent.

Aminoalkylhalide compounds are known. In one or more embodiments, the aminoalkylhalide compounds include tertiaryaminoalkylhalide compounds. These compounds are disclosed, for example, in U.S. Pat. Nos. 5,852,189, 5,574,109, 5,786,441, 5,912,343, 5,736,617, and 5,916,976, which are incorporated herein by reference. The halide ion of the aminoalkylhalide compound may include chloride, bromide, iodide, and fluoride ions. In one or more embodiments, the halide ion includes chloride ion.

Examples of suitable tertiaryaminoalkylhalides include 3-hexamethyleneiminepropyl chloride, or 2-(2-chloroethyl)-1-methylpyrolidine, or 3-chloromethyl-1-methylpiperidine or 3-dimethylaminopropyl chloride, or 3-pyrrolidinopropyl chloride, and mixtures thereof.

The lithium can be provided from lithium metal.

In one or more embodiments, electride solvents include those solvents that solubilize electrons. Electride solvents are discussed in U.S. Pat. No. 5,877,336, which is incorporated therein by reference.

In one or more embodiments, the electride solvent has a boiling point of less than 100° C., in other embodiments less than 80° C., in other embodiments less than 30° C., and in other embodiments less than 20° C., and in certain embodiments from about −50° C. to about 70° C.

Examples of electride solvents include tetrahydrofuran (THF) and dimethyl ether.

In one or more embodiments, the concentration of the aminoalkylhalide compound within the electride solvent at or before reaction with lithium is from about 0.2 to about 2 molar, in other embodiments from about 0.5 to about 1.5 molar, and in other embodiments from about 0.6 to about 1.2 molar.

In one or more embodiments, an excess of lithium is reacted with the aminoalkylhalide. In one or more embodiments, the mole ratio of lithium to equivalents of halide within the aminoalkylhalide compound is from about 2.0:1 to about 12:1, in other embodiments from about 2.5:1 to about 9:1, and in other embodiments from about 3.0:1 to about 4:1.

In one or more embodiments, the reaction between the lithium and the aminoalkylhalide takes place at or below the boiling point of the electride solvent. For example, the reaction takes place at a temperature of about −78° C. to about 50° C., in other embodiments from about −50° C. to about 30° C., and in other embodiments from about −30° C. to about 0° C.

In one or more embodiments, the reaction can be carried out at or above atmospheric pressure. In one or more embodiments, the reaction can take place at 1 atmosphere, in other embodiments from about 1.1 atmospheres to about 2 atmospheres, and in other embodiments up to about 4 or 6 atmospheres. In one or more embodiments, the reaction between the aminoalkylhalide and the lithium takes place under an inert atmosphere, where the inert atmosphere refers to those gases that will not react with the lithium metal. In one or more embodiments, the reaction takes place under an argon atmosphere.

The time of the reaction may vary based upon the type of aminoalkylhalide employed. In one or more embodiments, the reaction may proceed to an extent that at least 60%, in other embodiments at least 70%, in other embodiments at least 80%, in other embodiments at least 90%, in other embodiments at least 95%, in other embodiments at least 98%, and in other embodiments at least 99%, and in certain embodiments about 100% of the aminoalkylhalides are converted to aminoalkyllithium compounds.

As known by those skilled in the art, Zerewitinoff-active compounds include those compounds that will react with methylmagnesium iodide or bromide. As used herein, a non-Zerewitinoff solvent includes those solvents that will not react with methylmagnesium iodide or bromide. Without limiting the scope of the invention, it is believed that Zerewitinoff compounds react with methylmagnesium iodide or bromide via active hydrogens or carbonyls. Active hydrogens include those hydrogen atoms connected to an oxygen, nitrogen, sulfur, or phosphorous atom. Carbonyls can be included within esters, ketones, or aldehyde groups.

In one or more embodiments, the non-Zerewitinoff solvent has a solubility parameter of from about 19.1 to about 19.7 MPa^{1/2} in other embodiments from about 19.2 to about 19.6 MPa^{1/2} MPa^{1/2}, in other embodiments from about 19.3 to about 19.5 MPa^{1/2}, and in other embodiments about 19.4 MPa^{1/2}. In these or other embodiments, the solubility parameter of the non-Zerewitinoff solvent is at least 18.0 MPa^{1/2}, in other embodiments at least 18.5 MPa^{1/2}, in other embodiments at least 19.0 MPa^{1/2}, in other embodiments at least 19.1 MPa^{1/2}, in other embodiments at least 19.2 MPa^{1/2}, and in other embodiments at least 19.3 MPa^{1/2}. In these or other embodiments, the solubility parameter of the non-Zerewitinoff solvent is less than less than 22.0 MPa^{1/2}, in other embodiments less than 21.0 MPa^{1/2}, in other embodiments 20.0 MPa^{1/2}, in other embodiments less than 19.8 MPa^{1/2}, in other embodiments less than 19.7 MPa^{1/2}, in other embodiments less than 19.6 MPa^{1/2}, and in other embodiments less than 19.5 MPa^{1/2}.

The solubility parameter is a value defined by the formula: (ΔH/V)^{1/2} in which ΔH and V are a molar heat of vaporization and a molar volume of the solvent, respectively. As is generally known, the smaller the differential in solubility parameter between the solvent and the solute, the higher the maximum concentration of solute in solvent.

The solubility parameter is described in many publications (for example, “Polymer Handbook (fourth edition)”, by J. Brandrup et. al., VII/671 to VII/714).

Solubility parameter is a term known in the art as discussed in the Kirk-Othmer, Encyclopedia of Chemical Technology, Second Addition, Supplement at pp. 899-910 (1971), Rosen, Polymer Solubility and Solutions, Fundamental Principles of Polymeric Materials, pp. 74-87 (1982), and Grulke, Solubility Parameter Values, Polymer Handbook, Third Edition, pp. VII/519-VII/559 (1989), which are incorporated herein by reference. Solubility parameter has been defined as the square root of the energy of vaporization per cubic centimeter of a solvent. Thus, δ=[(ΔE_{V})/(V)]^{1/2}; where ΔE_{V} is energy of vaporization and V is molar volume. Solubility parameter is also expressed as δ²=δ_{D}²+δ_{E}²+δ_{H}² where δ_{D} is the dispersion component of the solubility parameter; δ_{E} is the polar component of the solubility parameter; and δ_{H} is the hydrogen bonding component of the solubility parameter. These parameters are available for a large number of solvents as set forth in Table I on pages 892-896 of the Kirk-Othmer text, and pages 525-539 of the Grulke text.

In one or more embodiments, the boiling point of the non-Zerewitinoff solvent is at least 10° C. different that the polymerization solvent employed in the diene polymerization as hereinafter described. For example, where hexanes are employed as the polymerization solvent, the non-Zerewitinoff solvent may have a boiling point of less than 60° C., in other embodiments less than 55° C., and in other embodiments less than 50° C., likewise, where hexanes are employed as the polymerization solvent, the non-Zerewitinoff solvent may have a boiling point in excess of 80° C., in other embodiments in excess of 90° C., and in other embodiments in excess of 120° C. In other embodiments, where a solvent such as pentane or where pentanes are employed as the polymerization solvent, the non-Zerewitinoff solvent may have a boiling point that is less than about 25° C. or greater than about 45° C.

Exemplary non-Zerewitinoff solvents include dibenzylether, benzene, tetrahydronaphthalene, bis (m-phenoxyphenyl)ether, bis (2-methoxyethyl)ether, pyridine, furan, phenetole, 1,4-dioxane, 1,3-dioxane, anisole, and mixtures of two or more thereof. As is generally known in the art, the solubility parameter of dibenzylether is 19.2 MPa^{1/2}, tetrahydronaphthalene is 20.0 MPa^{1/2}, bis(m-phenoxyphenyl)ether is 20.5 MPa^{1/2}, bis(2-methoxyethyl)ether is 21.3 MPa^{1/2}, pyridine is 21.7 MPa^{1/2}, furan is 19.2 MPa^{1/2}, phenetole is 18.9 MPa^{1/2}, anisole is 19.4 MPa^{1/2}, 1,4-dioxane is 20.5 MPa^{1/2}, and 1,3-dioxane is 19.8 MPa^{1/2}. In one or more embodiments, the non-Zerewitinoff solvent is anisole. In one or more embodiments, blends of two or more non-Zerewitinoff solvents may be employed to tailor a particular solubility parameter. As is generally known in the art, blends can be made and the solubility parameter of the blend can be tailored by a simple additive phenomenon. In particular embodiments, blends of non-Zerewitinoff solvents are formed to achieve a solubility parameter of 19.4 MPa^{1/2}. Those skilled in the art will appreciate that the present invention can also be practiced by employing a blend of non-Zerewitinoff solvents whose individual solubility parameters are outside of the preferred ranges set forth herein yet whose blended solubility parameters fall within the solubility parameters herein.

In one or more embodiments, the order in which the solvents are added or removed can vary. In one or more embodiments, the non-Zerewitinoff solvent is added before the electride solvent is removed. In another embodiment, the electride solvent is removed before the non-Zerewitinoff solvent is added. In yet other embodiments, the non-Zerewitinoff solvent is added while or during removal of the electride solvent.

Removal of the electride solvent from the solution can occur by employing standard techniques. For example, the electride solvent can be removed by distillation procedures. These distillation procedures can include heating the solution and/or lowering the atmospheric pressure of the solution.

In one or more embodiments, the process of the present invention yields a highly concentrated solution of aminoalkyllithium in a solvent including the non-Zerewitinoff solvent. In one or more embodiments, the solvent includes at least 50% by volume, in other embodiments at least 75% by volume, in other embodiments at least 90% by volume, and in other embodiments about 100% by volume non-Zerewitinoff solvent.

In one or more embodiments, the concentration of aminoalkyllithium within the solvent including the non-Zerewitinoff solvent is greater than 0.3 Molar, in other embodiments at least 0.5 Molar, in other embodiments at least 0.75 Molar, in other embodiments at least 1.0 Molar, in other embodiments at least 1.25 Molar, in other embodiments at least 1.5 Molar, and in other embodiments at least 1.75 Molar.

In one or more embodiments, the solutions of aminoalkyllithium compound in a solvent including the non-Zerewitinoff solvent are stable to the extent that less than 1 mole percent, in other embodiments less than 0.5 mole percent, and in other embodiments less than 0.3 mole percent of the aminoalkyllithium compound decays at 20° C. for a period of one week.

In view of the stability and concentrated nature of the aminoalkyllithium solutions prepared according to the present invention, one or more embodiments of the present invention are directed toward methods of storing and/or transporting these highly concentrated solutions. Also, one or more embodiments of this invention are directed toward the use of these highly concentrated solutions within anionic polymerization processes. These processes may include those that polymerize conjugated dienes, optionally together with comonomer such as vinyl aromatics (e.g., styrene), within aliphatic solvents such as various mixtures of hexanes. The highly concentrated solutions of aminoalkyllithium compounds within solvents including non-Zerewitinoff solvent can be added directly to reaction vessels that include polymerization solvents and monomer.

Polymerization solvents may include, for example, aliphatic solvents. In one or more embodiments, aliphatic solvents may include a blend of hexanes.

The anionic initiators of the present invention are suitable for use in any anionic polymerization especially rubbers. Monomers that can be polymerized include conjugated dienes having a total of from 4 to 10 carbon atoms such as 1,3-butadiene, isoprene, 1,3-pentadiene, 2,3-dimethyl-1-3-butadiene, 2-methyl-1,3-pentadiene, 2,3-dimethyl-1,3-pentadiene, 2-phenyl-1,3-butadiene, and 4,5-diethyl-1,3-octadiene. Conjugated dienes can be polymerized in the presence of various vinyl-substituted aromatic monomers having a total of from 8 to 12 carbon atoms such as styrene, 1-vinylnaphthalene, 3-methylstyrene (p-methylstyrene), 3-5-diethylstyrene, and the like. The number average molecular weight of the polymers generated show good correlation with the calculated molecular weight.

Conventional modifiers can be utilized in association with the polymerization reaction to control various aspects such as the amount of 1,2, or 3,4-vinyl repeat units or 1,4 repeat units of the formed rubber, e.g., through the utilization of OOPS (2,2′-ditetrahydrofuryl)propane), tetramethylethyldiamine, tetrahydrofuran, and the like.

A particular utility of the anionic initiators of the present inventions is in the polymerization of rubbers for tires such as tread rubber, carcass rubber, sidewall rubber, and the like.

Various modifications and alterations that do not depart from the scope and spirit of this invention will become apparent to those skilled in the art. This invention is not to be duly limited to the illustrative embodiments set forth herein.

What is claimed is:

1. A process for producing an aminoalkyllithium solution, the process comprising:
reacting an aminoalkylhalide with lithium in the presence of an electride solvent to form a solution of aminoalkyllithium;
adding a non-Zerewitinoff solvent having a solubility parameter of at least 18.0 and less than 22.0 MPa^{1/2}, and
removing the electride solvent, where said electride solvent and said non-Zerewitinoff solvent are distinct solvents thereby forming a solution of the aminoalkyllithium in the non-Zerewitinoff solvent.

2. The process of claim 1, where said electride solvent has a boiling point below 100° C.

3. The process of claim 1, where said electride solvent is selected from the group consisting of tetrahydrofuran, dimethyl ether, and mixtures thereof.

4. The process of claim 1, where said non-Zerewitinoff solvent has a boiling point below about 60° C. or above about 80° C.

5. The process of claim 1, where said non-Zerewitinoff solvent selected form the group consisting of dibenzylether, furan, phenetole, 1,4-dioxane, 1,3-dioxane, anisole, and mixtures of two or more thereof.

6. The process of claim 5, where said non-Zerewitinoff solvent is anisole.

7. The process of claim 1, where the solution of aminoalkyllithium in the non-Zerewitinoff solvent includes greater than 0.3 Molar aminoalkyllithium dissolved in the non-Zerewitinoff solvent at a temperature of from about 25° C. to about 30° C.

8. The process of claim 1, where the solution of aminoalkyllithium in the non-Zerewitinoff solvent includes greater than 0.5 Molar aminoalkyllithium dissolved in the non-Zerewitinoff solvent at a temperature of from about 25° C. to about 30° C.

9. The process of claim 1, where said step of adding a non-Zerewitinoff solvent occurs after said step of removing the electride solvent.

10. The process of claim 1, where said step of adding a non-Zerewitinoff solvent occurs before said step of removing the electride solvent.

11. The process of claim 1, where said step of adding a non-Zerewitinoff solvent occurs during said step of removing the electride solvent.

12. The process of claim 1, where the solution of aminoalkyllithium is stable to an extent that less than 1 mole percent of the aminoalkyllithium decays at 20° C. during a period of one week.

13. The process of claim 1, where the non-Zerewitinoff solvent has a solubility parameter of 19.1 to 19.7 MPa^{1/2}.

14. The process of claim 1, where the non-Zerewitinoff solvent has a solubility parameter of from about 19.2 to about 19.6 MPa^{1/2}.

15. The process of claim 1, where the non-Zerewitinoff solvent has a solubility parameter of from about 19.3 to about 19.5 MPa^{1/2}.

16. The process of claim 1, where the aminoalkyllithium is 3-hexamethyleneiminepropyl lithium and the non-Zerewitinoff solvent is anisole.

17. A composition comprising:
an aminoalkyllithium or the solution thereof; and
a non-Zerewitinoff solvent having a solubility parameter of at least 18.0 and less than 22.0 MPa^{1/2}and boiling point below about 60° C. and above about 80° C.

18. The process of claim 15, where the composition includes greater than 0.3 Molar aminoalkyllithium or the solute thereof, based on the total weight of the composition.

19. A process for producing an aminoalkyllithium solution, the process comprising:
reacting an aminoalkylhalide with lithium in the presence of an electride solvent to form a solution of aminoalkyllithium;
adding a non-Zerewitinoff solvent or blend thereof having a solubility parameter of at least 18.0 and less than 22.0 MPa^{1/2}, where said electride solvent and said non-Zerewitinoff solvent are distinct solvents, thereby forming a solution of the aminoalkyllithium in the non-Zerewitinoff solvent; and
removing the electride solvent.

20. The process of claim 19, where the non-Zerewitinoff solvent or blend thereof has a solubility parameter of from about 19.1 to about 19.7 MPa^{1/2}.
